(19) United States
(12) Patent Application Publication
(10) Pub. No.: US 2025/0360943 A1
(43) Pub. Date: Nov. 27, 2025

(54) METHOD FOR OBTAINING DATA, ELECTRONIC DEVICE, AND STORAGE MEDIUM

(71) Applicant: HON HAI PRECISION INDUSTRY CO., LTD., New Taipei (TW)

(72) Inventors: CHIH-TE LU, New Taipei (TW); Shih-Chao Chien, New Taipei (TW); Chin-Pin Kuo, New Taipei (TW)

(21) Appl. No.: 19/215,565

(22) Filed: May 22, 2025

(30) Foreign Application Priority Data
May 22, 2024 (CN) 202410640516.6

(51) Int. Cl. B60W 60/00; B60R 16/023; B60W 50/00; G06N 3/08; G07C 5/04

(52) U.S. Cl. CPC B60W 60/001; B60W 50/0097; G06N 3/08; G07C 5/04; B60R 16/0231; B60W 2050/0031; B60W 2420/403; B60W 2420/408; B60W 2520/10; B60W 2556/45; B60W 2556/50

(57) ABSTRACT

A method for obtaining data are provided. The method for obtaining data includes collecting first driving data of a vehicle at first preset time, and collecting a plurality of data sets of second driving data of the vehicle within a first preset period. The vehicle driving trajectory is generated according to the plurality of data sets of the second driving data, and training data is generated according to the first driving data and the vehicle driving trajectory. These method can improve the efficiency of collecting training data and the efficiency of training the neural network.

### FIELD

The present disclosure relates to a field of vehicles, and more particularly to a method for obtaining data, an electronic device, and a storage medium.

### BACKGROUND

In the development of autonomous driving technology, autonomous vehicles are confronted with various complex scenarios during a driving process, such as intricate road conditions, diverse weather conditions, and unexpected traffic incidents. To train a neural network that can accurately and completely simulate human driving behaviors, sufficient and exhaustive data is required.

However, in the relevant technologies, the collection of training data for neural networks predominantly mainly relies on manual labor. This approach not only requires substantial human resources and time investment with low efficiency, but also makes struggles to ensure the comprehensiveness and accuracy of the data. If the efficiency of collection training data cannot be improved, the training efficiency of the neural network will be affected.

### BRIEF DESCRIPTION OF THE DRAWINGS

FIG. 1 is a structural diagram of an electronic device in an embodiment of the present disclosure.

FIG. 2 is a flowchart diagram of a method for obtaining data in an embodiment of the present disclosure.

FIG. 3 is a flowchart diagram of a method for training neural network in an embodiment of the present disclosure.

FIG. 4 is a schematic diagram of receiving training data provided in an embodiment of the present disclosure.

FIG. 5 is a structural diagram of a vehicle in an embodiment of the present disclosure.

### DETAILED DESCRIPTION

It should be noted that “at least one” in this disclosure refers to one or more, and “multiple” refers to two or more than two. “And/or” describes an association of associated objects, indicating that there can be three relationships. For example, A and/or B can mean: A exists alone, A and B exist simultaneously, and B exists alone, where A, B can be singular or plural. Terms “first”, “second”, “third”, “fourth”, etc. (if present) in description, claims and drawings of this disclosure are used to distinguish similar objects, rather than to describe a specific order or sequence.

In the embodiments of this disclosure, words such as “exemplary” or “for example” are used to represent examples, illustrations or explanations. Any embodiment or design described as “exemplary” or “such as” in the embodiments of the present disclosure is not to be construed as preferred or advantageous over other embodiments or designs. Rather, use of words “exemplary” or “such as” is intended to present the concept in a concrete manner. The following embodiments and features in the embodiments may be combined with each other without conflict.

In the development of autonomous driving technology, autonomous vehicles are confronted with various complex scenarios during a driving process, such as intricate road conditions, diverse weather conditions, and unexpected traffic incidents. To train a neural network that can accurately and completely simulate human driving behaviors, sufficient and exhaustive data is required.

However, in the relevant technologies, the collection of training data for neural networks predominantly mainly relies on manual labor. This approach not only requires substantial human resources and time investment with low efficiency, but also makes struggles to ensure the comprehensiveness and accuracy of the data. If the efficiency of collection training data cannot be improved, the training efficiency of the neural network will be affected.

Furthermore, significant differences exist in road environment, traffic regulations, and driving behaviors in different regions. If exhaustive training data encompassing these differences cannot be obtained to train the neural network, the compromised adaptability and generalization ability of the neural network model will be affected, resulting in poor prediction accuracy of autonomous driving trajectory and driving safety.

In order to solve the above problems, a method for obtaining data and a method for training neural network are provided, these methods can improve the efficiency of obtaining training data and the training effectiveness of the neural network. The method for obtaining data and the method for training neural network may be applied in one or more electronic devices, and the method for obtaining data and the method for training neural network will be described below in combination with the application scenario and the flowchart.

The electronic device may include an electronic device such as an on-board device, a server, a computer, etc., and the embodiments of the present disclosure do not impose any limitation on the specific type of the electronic device. For example, the vehicle-mounted device may be an Electronic Control Unit (ECU) or a Body Control Module (BCM) of a vehicle. The server may be a single server, a cluster of servers, or a cloud server. Exemplarily, the method for obtaining data may be applied in the vehicle-mounted device and the method for training neural network may be applied in the server.

FIG. 1 is a structural diagram of an electronic device in an embodiment of the present disclosure. As shown in FIG. 1, an electronic device 10 may include a communication module 101, a storage device 102, a processor 103, an input/output (I/O) interface 104, and a bus 105. The processor 103 is coupled to the communication module 101, the storage device 102, and the I/O interface 104 through the bus 105, respectively.

The communication module 101 may include a wired communication module and/or a wireless communication module. The wired communication module can provide one or more of wired communication solutions such as Universal Serial Bus (USB), Controller Area Network (CAN), Local Interconnect Network (LIN), FlexRay, for example. The Wireless communication module can provide one or more of wireless communication solutions such as wireless fidelity (Wi-Fi), Bluetooth (BT), mobile communication network, frequency modulation (FM), near field communication (NFC), infrared (IR) technology.

The storage device 102 may include one or more random access memories (RAM) and one or more non-volatile memories (NVM). The random access memory can be directly read and written by the processor 103. The random access memory can be used to store executable programs (such as machine instructions) of an operating system or other running programs, and can also be used to store user and application data, etc. The random access memory can include static random-access memory (SRAM), dynamic random access memory (DRAM), synchronous dynamic random access memory (SDRAM), double data rate synchronous dynamic random access memory (DDR SDRAM), etc.

The non-volatile memory can also store executable programs and user and application data, etc., and the non-volatile memory can be loaded into the random access memory in advance for directly reading and writing by the processor 103. The non-volatile memory can include disk storage devices and flash memory. For example, the flash memory may be Nand Flash.

The storage device 102 is used to store one or more computer programs. The one or more computer programs are configured for execution by the processor 103. The one or more computer programs include a plurality of instructions. The plurality of instructions can be executed by the processor 103 for implementing the method for obtaining data and the method for training neural network executed on the electronic device 10.

In other embodiments, the electronic device 10 further includes an external memory interface for connecting to an external memory to expand a storage capacity of the electronic device 10.

The processor 103 may include one or more processing units. For example, the processor 103 may include an application processor (AP), a modem processor, a graphics processing unit (GPU), and an image signal processor (ISP), controller, video codec, digital signal processor (DSP), baseband processor, and/or neural network processing unit (NPU), for example. Different processing units can be independent devices or integrated in one or more processors.

The processor 103 provides computing and control capabilities. For example, the processor 103 is used to execute a computer program stored in the storage device 102 to implement the method for obtaining data and the method for training neural network.

The I/O interface 104 is used to provide a channel for user input or output. For example, the I/O interface 104 can be used to connect various input and output devices, such as a mouse, keyboard, touch device, display screen, etc., so that the user can input information. The I/O interface 104 can be used to visualize information.

The bus 105 is at least used to provide a communication channel between the communication module 101, the storage device 102, the processor 103, and the I/O interface 104 in the electronic device 10.

It can be understood that a structure illustrated in the embodiment of the present disclosure does not constitute a specific limitation on the electronic device 10. In other embodiments of the present disclosure, the electronic device 10 may include more or less components than shown in the figures, or some components may be combined, some components may be separated, or some components may be arranged differently. The components illustrated may be implemented in hardware, software, or a combination of software and hardware.

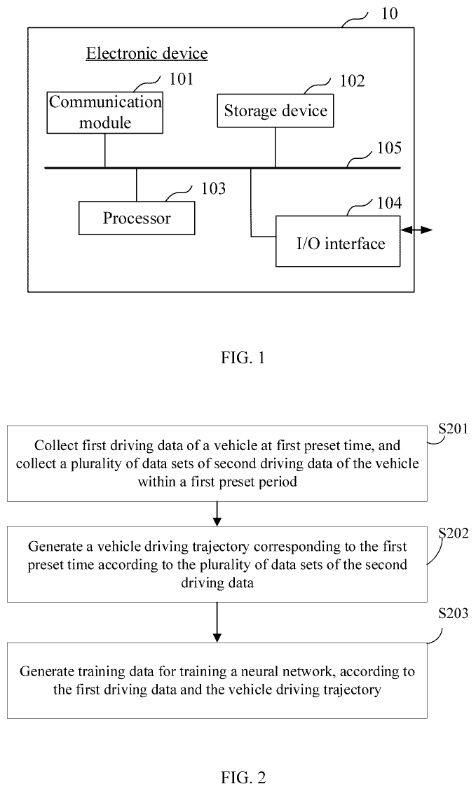

FIG. 2 is a flowchart diagram of a method for obtaining data in an embodiment of the present disclosure. The method for obtaining data is applied to an electronic device, such as the electronic device 10 in FIG. 1. In order to facilitate the illustration of the method for obtaining data provided by an embodiment of the present disclosure, the following will illustrate the method by taking the electronic device as a vehicle-mounted device.

In block S201, the vehicle-mounted device collects first driving data of a vehicle at first preset time, and collects a plurality of data sets of second driving data of the vehicle within a first preset period.

In one embodiment, the first preset time may be a time point or a time stamp, such as 9:00, for example. The first preset time may be predefined, and the embodiment does not limit a selection of the first preset time. The first preset period is after the first preset time, the first preset period may be predefined or modified according to user requirements, and the embodiment does not limit a selection of the first preset period. Each of the plurality of data sets of the second driving data may correspond to a time point within the first preset period. For example, in response that the first preset time is 9:00, the first preset period may be 9:01˜ 9:10, and a number of groups of the data sets of the second driving data may be 10, for example, there are 10 time points, such as 9:01, 9:02, 9:03 . . . 9:10 within the first preset period from 9:01 to 9:10.

In one embodiment, the vehicle-mounted device obtains data collected by sensors of the vehicle at the first preset time as the first driving data, based on a Controller Area Network bus (CANBus) of the vehicle. The vehicle-mounted device obtains driving status data of the vehicle at each time point within the first preset period as the second driving data, by using navigation sensor components of the vehicle.

The vehicle-mounted device may include a CANBus adapter, the CANBus adapter is connected to the CANBus, and the vehicle-mounted device may obtain the first driving data from the CANBus through the CANBus adapter.

The first driving data includes, but is not limited to images captured by a forward-facing camera, data detected by a radar, control data of a gas pedal, control data of a brake, control data of a steering wheel, an angle of the steering wheel, states of left and right directional lamps, gear information of a transmission of the vehicle, and blind-spot detection status.

Images captured by the forward camera include, but are not limited to images of detected road markings, pedestrians, vehicles, and other obstacles. The data detected by the radar includes, but is not limited to directions and speeds of obstacles, and the distances between the obstacles and the vehicle. The obstacles include, but are not limited to pedestrians and vehicles. The control data of the gas pedal includes, but is not limited to engine power and positions of the gas pedal of the vehicle. The control data of the brake includes, but is not limited to positions of a brake pedal and states of a brake system. The control data of the steering wheel includes, but is not limited to an angle of the steering wheel and a steering speed. The states of the left and right directional lamps include but are not limited to a power-on status and a power-off status. The gear position information of a vehicle transmission includes, but is not limited to driver (D) gear, park (P) gear, reverse (R) gear, or neutral (N) gear. The blind-spot detection state includes, but is not limited to an enabled state (ON) or a disabled state (OFF).

The sensors and the navigation sensor components may be configured into the vehicle.

The sensors include the forward-facing camera and the radar, the navigation sensor components include an Inertial Measurement Unit (IMU) component and a Global Positioning System (GPS) component. The driving status data includes speed, an acceleration, an angular velocity, an attitude, and coordinates of the vehicle at each time point within the first preset period. The vehicle attitude includes pitch angle, yaw angle and roll angle.

In one embodiment, the above mentioned descriptions of the first driving data, the second driving data, the sensors, and the navigation sensor components are illustrative examples, and the practical implementations are not limited to these.

In a trajectory planning process of autonomous driving vehicles, training data of a neural network can include driving states of the vehicle at each time point and the driving trajectories in the first preset period. This configuration enables a trained neural network model to accurately predict an autonomous driving trajectory of the vehicle for a predetermined time period based on driving data of a vehicle at any given time point. The first driving data is obtained from the CANBus through the CANBus adapter, and the second driving data of the vehicle is obtained through the sensors and the navigation sensor components. This realizes automatic collection of training data without relying on manual collection, thereby improving the collection efficiency of training data.

In block S202, the vehicle-mounted device generates a vehicle driving trajectory corresponding to the first preset time according to the plurality of data sets of the second driving data.

In one embodiment, the vehicle-mounted device stores the plurality of data sets of the second driving data as an array according to a chronological order, and each element in the array corresponds to a track point of the vehicle driving trajectory. Each of the track points in the vehicle driving trajectory may correspond to a time point within the first preset period, and each of the track points may correspond to the second driving data, such as speed, acceleration, an angular velocity, an attitude, and coordinates. For example, in response that the first preset period includes 10 time points between 9:01 to 9:10, the vehicle driving trajectory may include 10 track points, each track point corresponds to a time point.

In block S203, the vehicle-mounted device generates training data for training a neural network, according to the first driving data and the vehicle driving trajectory.

In one embodiment, the vehicle-mounted device determines the first driving data and the vehicle driving trajectory as the training data corresponding to the first preset time. The neural network may be predefined and is not limited to specified types. For example, the neural network may be Convolutional Neural Networks (CNNs), Recurrent Neural Networks (RNNs), Long Short-Term Memory (LSTM), Reinforcement Learning Network, Fusion Networks, and combinations of one or more types of Control Networks. It should be noted that the acquisition of the first set of vehicular data and multiple second sets of vehicular data may require a non-negligible duration, subject to the sampling frequency of onboard sensors and computational latency of data fusion modules.

In one embodiment, it may take a certain amount of time to collect the first driving data and the second driving data, and the vehicle-mounted device may store collected data to a cache module (e.g., a cache, a caching unit) before the collection of the first driving data and the second driving data is completed. After the first driving data and the plurality of sets of the second driving data have been collected, the vehicle-mounted device may extract the first driving data and the plurality of sets of the second driving data from the cache module through a processor (e.g., the processor 103 in FIG. 1), generate the vehicle driving trajectory corresponding to the first preset time according to the plurality of data sets of the second driving data, and generate the training data according to the first driving data and the vehicle driving trajectory.

In one embodiment, before completing a data collection of the first driving data and the plurality of data sets of the second driving data, the vehicle-mounted device may store the collected data in the cache module, so that even if a data collection process is subject to any interference or interruption, the vehicle-mounted device is capable of recovering the training data from the cache module, thereby avoiding loss or damage of the training data, and ensuring the integrity and accuracy of the training data.

In one embodiment, the vehicle-mounted device may process the first driving data and the vehicle driving trajectory, and determine the processed first driving data and the processed vehicle driving trajectory as the training data corresponding to the first preset time. The processing of the first driving data and the vehicle driving trajectory may include a labeling process.

For example, the vehicle-mounted device may label the first driving data and the vehicle driving trajectory with respect to traffic rules, driving behaviors, traffic signals, road conditions, road signs, etc. For example, it can label whether a driver should yield and specific rules and conditions for yielding. It can also label under which circumstances the vehicle has priority access and the specific rules and details of the priority access. Additionally, it can label whether the vehicle is permitted to turn right on a red light. Other annotations may include the meanings and purposes of various road markings, as well as the colors and flashing modes of traffic signals, and corresponding traffic regulations, etc.

In one embodiment, by labeling the first driving data and the vehicle driving trajectory, information amount in the training data can be increased, thus, it can improve the training effectiveness of the neural network, so that the trained neural network model can more accurately recognize and determine various situations in the driving of the vehicle.

In one embodiment, the vehicle-mounted device is communicatively connected to a server, the vehicle-mounted device may also send the training data to the server, and enable the server to perform a training of the neural network according to received training data and obtain the neural network model. The neural network model can be configured to predict an autonomous driving trajectory of a vehicle.

In one embodiment, since each of the training data includes the first driving data and the vehicle driving trajectory, the server is enabled to invoke the neural network to predict a predicted driving trajectory of the vehicle during the first preset period based on the first driving data in each of the training data, calculate a loss value of the neural network based on the predicted driving trajectory and the vehicle driving trajectory corresponding to each of the training data, and adjust parameters of the neural network until the loss value falls in a preset range, so that the neural network model is obtained. The server determines the trained neural network as a neural network model.

The preset range can be predefined. For example, the preset range may be defined to be 0.1˜0.2.

In one embodiment, the vehicle-mounted device may also determine the first driving data and the second driving data as the training data.

In one embodiment, the vehicle-mounted device may also send the third driving data of the vehicle at a second preset time to the server, which predicts an autonomous driving trajectory of the vehicle within a second preset period by using the neural network model based on the third driving data, the second preset period is after the second preset time. The vehicle-mounted device receives the autonomous driving trajectory sent by the server for the third driving data, and controls an automatic driving of the vehicle within the second preset period according to the autonomous driving trajectory.

The second preset time can be predefined, and the embodiment does not restrict the second preset time. Data type of the third driving data may refer to the first driving data, and the related descriptions are not repeatedly provided.

In one embodiment, a neural network may be stored in the vehicle-mounted device. The vehicle-mounted device may train the neural network base on the training data, and obtain a neural network model without sending the training data to the server.

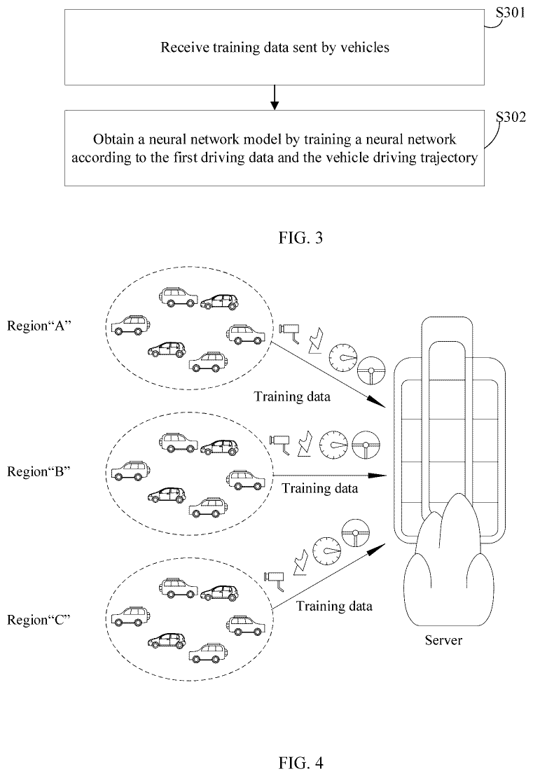

In one embodiment, the method for obtaining data includes a method for training neural network. For a training way of the neural network, reference can be made to the relevant description in FIG. 3, and the embodiment will not repeat the description.

In some embodiments, the method for obtaining data is provided. The vehicle-mounted device obtains the first driving data of the vehicle at the first preset time and the plurality of data sets of the second driving data within the first preset period. The vehicle driving trajectory corresponding to the first preset time is generated based on the plurality of data sets of the second driving data, and the training data is generated based on the first driving data and the vehicle driving trajectory. This achieves the automatic collection of the training data for the neural network without relying on manual collection, thereby improving the collection efficiency of the training data.

FIG. 3 is a flowchart diagram of a method for training neural network in an embodiment of the present disclosure. The method for training neural network is applied to an electronic device, such as the electronic device 10 in FIG. 1. In order to facilitate the illustration of the method for training neural network provided by an embodiment of the present disclosure, the following will illustrate the method by taking the electronic device as a server.

In block S301, the server receives training data sent by vehicles.

In one embodiment, the training data sent by each of the vehicles includes first driving data of each of the vehicles at first preset time and a vehicle driving trajectory of each of the vehicles within a first preset period, the first preset period being after the first preset time.

In one embodiment, the server and the vehicle may be connected through a vehicle networking technology. The first preset time and the first preset period can refer to the description in block S201, and the embodiment will not repeat the description. The vehicle driving trajectory is generated by a plurality of data sets of second driving data within the first preset period. The vehicle driving trajectory, the first driving data, and the plurality of data sets of the second driving data can refer to the description in block S201, and this disclosure will not repeat the description. In one embodiment, the server may receive the training data sent by the vehicles from different regions, and the different regions may be different regions in different countries or different regions in the same country. For example, as shown in FIG. 4, FIG. 4 is a schematic diagram of receiving training data provided in an embodiment of the embodiment. The server may receive the training data sent by the vehicles from region “A”, region “B”, and region “C”. In order to more clearly illustrate the method for obtaining training data, devices (for example, forward-facing camera, steering wheel, speedometer, and foot pedal) corresponding to the training data can be represented by icons.

In block S302, the server obtains a neural network model by training a neural network according to the first driving data and the vehicle driving trajectory.

In one embodiment, the neural network model is invoked to predict an autonomous driving trajectory of each of the vehicles. The neural network may be predefined and is not limited to specific types. For example, the neural network may be Convolutional Neural Networks (CNNs), Recurrent Neural Networks (RNNs), Long Short-Term Memory (LSTM), Reinforcement Learning Network, Fusion Networks, and combinations of one or more types of Control Networks.

In one embodiment, the server performs a prediction using the neural network, based on the first driving data of each of the vehicles at the first preset time, and obtains a predicted driving trajectory of each of the vehicles within the first preset period correspondingly. The server calculates a loss value of the neural network according to the vehicle driving trajectory and the predicted driving trajectory. The server obtains the neural network model by adjusting the neural network until the loss value falls into a preset range.

The preset range can be predefined. For example, the preset range may be 0.1˜ 0.2.

The predicted driving trajectory is a trajectory that causes the vehicle to perform automatic driving, and the predicted driving trajectory corresponds to the vehicle driving trajectory. In response that the vehicle driving trajectory includes a plurality of trajectory points, each of the trajectory points correspond to the second driving data, the predicted driving trajectory also includes the predicted driving data corresponding to each of the trajectory points. The server may calculate a loss value of the neural network based on the second driving data and the corresponding predicted driving data. The method for calculating the loss value based on the second driving data and the corresponding predicted driving data may be predefined, and the embodiment does not limit the implementation of the method for calculating the loss value. For example, the server may use a sum or a weighted sum of differences between the predicted driving data and the corresponding second driving data as the loss value of the neural network.

In one embodiment, the server may receive the third driving data sent by the vehicle-mounted device of the vehicle at the second preset time. The server predicts an autonomous driving trajectory of the vehicle within a second preset period by using the neural network model based on the third driving data, the second preset period is after the second preset time. The server sends the autonomous driving trajectory to the vehicle-mounted device, so as to enable the vehicle-mounted device to control the automatic driving of the vehicle within the second preset period according to the autonomous driving trajectory.

The second preset time can be predefined, and the embodiment does not restrict the second preset time. Data type of the third driving data may refer to the first driving data, and the embodiment will not repeat the description. The process of for predicting the autonomous driving trajectory of the vehicle within the second preset period based on the third driving data, by utilizing the neural network model, is described in the above embodiments.

In some embodiments, the server trains the neural network based on the training data sent by vehicles from different regions, causing the neural network to learn complex and comprehensive information such as road condition information and driving knowledge, thereby enabling the trained neural network model to better understand and adapt to various changes in the traffic environment in the prediction process. Thus, the trained neural network model makes more accurate and safe driving decisions, and generates accurate autonomous driving trajectories.

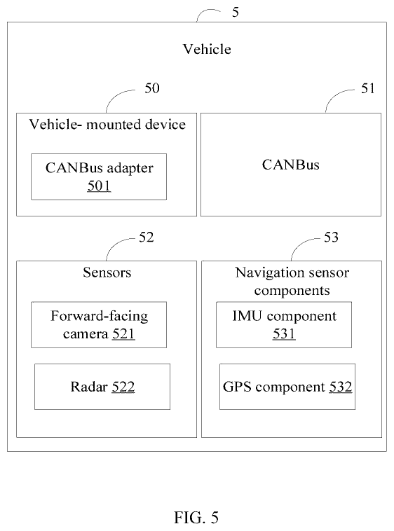

FIG. 5 is a structural diagram of a vehicle in an embodiment of the present disclosure. As shown in FIG. 5, a vehicle 5 may include a vehicle-mounted device 50, a CANBus 51, sensors 52 and navigation sensor components 53. The vehicle-mounted device 50 may include a CANBus adapter 501. The sensors 52 may include a forward-facing camera 521 and a radar 522. The navigation sensor components 53 may include an Inertial Measurement Unit (IMU) component 531 and a Global Positioning System (GPS) component 532.

A computer-readable storage medium is also provided in the present disclosure. A computer program is stored on the computer-readable storage medium. The computer program includes program instructions. A method implemented when the program instructions are executed may refer to methods in above-mentioned embodiments of this disclosure.

The computer-readable storage medium may be an internal memory of the electronic device described in the above embodiment, such as a hard disk or memory of the electronic device. The computer-readable storage medium may also be an external storage device of the electronic device, such as a plug-in hard disk, a Smart Media Card (SMC), or a Secure Digital (SD) card, a Flash Card, etc. equipped on the electronic device.

In some embodiments, the computer-readable storage medium may include a storage program area and a storage data area, wherein the storage program area may store an operating system, at least one application program required for a function, etc. The storage data area may store data created based on a use of the electronic device, etc.

In the above embodiments, each embodiment is described with its own emphasis. For parts that are not detailed or documented in a certain embodiment, please refer to relevant descriptions of other embodiments.

One ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular disclosure and design constraints of the technical solution. A person skilled in the art may use different methods to implement the described functions for each particular disclosure, but such implementations should not be considered outside the scope of this disclosure.

The above embodiments are only used to illustrate technical solutions of the present disclosure and are not to be taken as restrictions on the technical solutions. Although the embodiment has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method to obtain data, the method comprising:
collecting first driving data of a vehicle at first preset time, and collecting a plurality of data sets of second driving data of the vehicle within a first preset period, the first preset period being after the first preset time by a vehicle-mounted device;
generating a vehicle driving trajectory corresponding to the first preset time by the vehicle-mounted device, according to the plurality of data sets of the second driving data; and
generating training data for training a neural network by the vehicle-mounted device, according to the first driving data and the vehicle driving trajectory.

2. The method for obtaining data of claim 1, wherein collecting the first driving data of the vehicle at the first preset time, and collecting the plurality of data sets of the second driving data of the vehicle within the first preset period by the vehicle-mounted device, comprises:
obtaining data collected by sensors of the vehicle at the first preset time as the first driving data, based on a Controller Area Network bus of the vehicle; and
obtaining driving status data of the vehicle at each time point within the first preset period as the second driving data, by using navigation sensor components of the vehicle.

3. The method for obtaining data of claim 2, wherein the sensors comprise a forward-facing camera and a radar, the navigation sensor components comprise an Inertial Measurement Unit component and a Global Positioning System component, and the driving status data comprises a speed, an attitude and coordinates of the vehicle at each time point within the first preset period.

4. The method for obtaining data of claim 1, wherein generating the vehicle driving trajectory corresponding to the first preset time by the vehicle-mounted device, according to the plurality of data sets of the second driving data comprises:
storing the plurality of data sets of the second driving data as an array according to a chronological order, and each element in the array corresponding to a track point of the vehicle driving trajectory.

5. The method for obtaining data of claim 4, further comprising:
sending the training data to a server by the vehicle-mounted device, and enabling the server to train the neural network according to received training data and obtain a neural network model, which is configured to predict an autonomous driving trajectory of a vehicle.

6. The method for obtaining data of claim 5, further comprising:
sending third driving data of the vehicle at a second preset time to the server by the vehicle-mounted device, which predicts an autonomous driving trajectory of the vehicle within a second preset period by using the neural network model based on the third driving data, the second preset period being after the second preset time;
receiving the autonomous driving trajectory sent by the server for the third driving data, and controlling an automatic driving of the vehicle within the second preset period according to the autonomous driving trajectory by the vehicle-mounted device.

7. The method for obtaining data of claim 1, further comprising:
receiving training data by a server, the training data sent by each of vehicles comprising first driving data of each of the vehicles at first preset time and a vehicle driving trajectory of each of the vehicles within a first preset period, the first preset period being after the first preset time, the vehicle driving trajectory being generated by a plurality of data sets of second driving data within the first preset period; and
obtaining a neural network model by training a neural network by the server, according to the first driving data and the vehicle driving trajectory, the neural network model being invoked to predict an autonomous driving trajectory of each of the vehicles.

8. The method for obtaining data of claim 7, wherein obtaining the neural network model by training the neural network by the server, according to the first driving data and the vehicle driving trajectory comprises:
obtaining a predicted driving trajectory of each of the vehicles within the first preset period by performing a predicting processing using the neural network, based on the first driving data of each of the vehicles at the first preset time;
calculating a loss value of the neural network according to the vehicle driving trajectory and the predicted driving trajectory; and
obtaining the neural network model by adjusting the neural network until the loss value is within a preset range.

9. An electronic device comprising:
a processor; and
a storage device storing a plurality of instructions, which when executed by the processor, cause the processor to:
collect first driving data of a vehicle at first preset time, and collect a plurality of data sets of second driving data of the vehicle within a first preset period, the first preset period being after the first preset time;
generate a vehicle driving trajectory corresponding to the first preset time according to the plurality of data sets of the second driving data; and
generate training data for training a neural network, according to the first driving data and the vehicle driving trajectory.

10. The electronic device of claim 9, wherein the processor is further caused to:
obtain data collected by sensors of the vehicle at the first preset time as the first driving data, based on a Controller Area Network bus of the vehicle; and
obtain driving status data of the vehicle at each time point within the first preset period as the second driving data, by using navigation sensor components of the vehicle.

11. The electronic device of claim 10, wherein the sensors comprise a forward-facing camera and a radar, the navigation sensor components comprise an Inertial Measurement Unit component and a Global Positioning System component, and the driving status data comprises a speed, an attitude and coordinates of the vehicle at each time point within the first preset period.

12. The electronic device of claim 9, wherein the processor is further caused to:
store the plurality of data sets of the second driving data as an array according to a chronological order, and each element in the array corresponding to a track point of the vehicle driving trajectory.

13. The electronic device of claim 12, wherein the processor is further caused to:
send the training data to a server, and enable the server to train the neural network according to received training data and obtain a neural network model, which is configured to predict an autonomous driving trajectory of a vehicle.

14. The electronic device of claim 13, wherein the processor is further caused to:
send third driving data of the vehicle at a second preset time to the server, which predicts an autonomous driving trajectory of the vehicle within a second preset period by using the neural network model based on the third driving data, the second preset period being after the second preset time;
receive the autonomous driving trajectory sent by the server for the third driving data, and control an automatic driving of the vehicle within the second preset period according to the autonomous driving trajectory.

15. A non-transitory storage medium having stored thereon at least one computer-readable instructions, which when executed by a processor of an electronic device, causes the processor to perform a method for obtaining data, the method comprising:
collecting first driving data of a vehicle at first preset time, and collecting a plurality of data sets of second driving data of the vehicle within a first preset period, the first preset period being after the first preset time;
generating a vehicle driving trajectory corresponding to the first preset time according to the plurality of data sets of the second driving data; and
generating training data for training a neural network, according to the first driving data and the vehicle driving trajectory.

16. The non-transitory storage medium of claim 15, wherein collecting the first driving data of the vehicle at the first preset time, and collecting the plurality of data sets of the second driving data of the vehicle within the first preset period, comprises:
obtaining data collected by sensors of the vehicle at the first preset time as the first driving data, based on a Controller Area Network bus of the vehicle; and
obtaining driving status data of the vehicle at each time point within the first preset period as the second driving data, by using navigation sensor components of the vehicle.

17. The non-transitory storage medium of claim 16, wherein the sensors comprise a forward-facing camera and a radar, the navigation sensor components comprise an Inertial Measurement Unit component and a Global Positioning System component, and the driving status data comprises a speed, an attitude and coordinates of the vehicle at each time point within the first preset period.

18. The non-transitory storage medium of claim 15, wherein generating the vehicle driving trajectory corresponding to the first preset time according to the plurality of data sets of the second driving data comprises:
storing the plurality of data sets of the second driving data as an array according to a chronological order, and each element in the array corresponding to a track point of the vehicle driving trajectory.

19. The non-transitory storage medium of claim 18, the method comprising:
sending the training data to a server, and enabling the server to train the neural network according to received training data and obtain a neural network model, which is configured to predict an autonomous driving trajectory of a vehicle.

20. The non-transitory storage medium of claim 19, the method comprising:
sending third driving data of the vehicle at a second preset time to the server, which predicts an autonomous driving trajectory of the vehicle within a second preset period by using the neural network model based on the third driving data, the second preset period being after the second preset time;
receiving the autonomous driving trajectory sent by the server for the third driving data, and controlling an automatic driving of the vehicle within the second preset period according to the autonomous driving trajectory.
